(19) United States
(12) Patent Application Publication
(10) Pub. No.: US 2022/0129957 A1
(43) Pub. Date: Apr. 28, 2022

(54) FEEDBACK ENRICHMENT SYSTEM AND METHOD

(71) Applicant: Glassbox Ltd., Petah Tikva (IL)

(72) Inventors: Yaron GUETA, Hod Hasharon (IL); Noam SHWARTZ, Kfar-Saba (IL)

(21) Appl. No.: 17/076,818

(22) Filed: Oct. 22, 2020

(51) Int. Cl. G06Q 30/02; G06F 3/0481

(52) U.S. Cl. CPC G06Q 30/0282; G06F 2203/011; G06F 3/0481; G06Q 30/0201

(57) ABSTRACT

A feedback enrichment system comprising a processing circuitry configured to: obtain (a) user journey information of a plurality of user journeys, each performed in a respective session within a website or a computerized application, each of the user journeys including information of a respective series of actions made by a corresponding user, within the website or the computerized application, in order to achieve a goal, and (b) feedback information, indicative of feedback provided by the user associated with a feedback user journey of the user journeys; identify matching user journeys of the user journeys being the user journeys that meet a similarity criterion with the feedback journey, wherein a second user associated with at least one of the matching user journeys did not provide feedback for the respective matching user journey; and determine a feedback impact score associated with the feedback information, based on analysis of the matching user journeys.

### TECHNICAL FIELD

The invention relates to a system and method for enrichment of feedback, and more specifically to a system and method for enrichment of feedback provided by users of a website or a computerized application.

### BACKGROUND

Many websites and computerized applications (e.g. applications that can be executed on computerized devices such as computers, smartphones, tablets, smart-watches, etc.) enable users to provide feedback about the user's experience when using the website/computerized application. However, most users do not take the time to provide any feedback, inter ilia due to the fact that it consumes their time. It is extremely hard to get valuable insights from analysis of the users feedback due to the fact that it is provided very rarely.

There is thus a need in the art for a new feedback enrichment system and method.

### GENERAL DESCRIPTION

In accordance with a first aspect of the presently disclosed subject matter, there is provided a feedback enrichment system, the feedback enrichment system comprising a processing circuitry configured to: obtain (a) user journey information of a plurality of user journeys, each performed in a respective session within a website or a computerized application, each of the user journeys including information of a respective series of actions made by a corresponding user, within the website or the computerized application, in order to achieve a goal, and (b) feedback information, indicative of feedback provided by the user associated with a feedback user journey of the user journeys; identify matching user journeys of the user journeys being the user journeys that meet a similarity criterion with the feedback journey, wherein a second user associated with at least one of the matching user journeys did not provide feedback for the respective matching user journey and determine a feedback impact score associated with the feedback information, based on analysis of the matching user journeys.

In some cases, the user journey information further includes performance information indicative of performance of the website or the computerized application during at least part of the respective session.

In some cases, the performance information includes an indication of a time since performance of at least one of the actions until completion of execution of code associated with the action within the website or the computerized application.

In some cases, the user journey information further includes behavioral information indicative of a behavior of the corresponding user during at least part of the respective session.

In some cases, the behavioral information includes one or more of: an indication of time passing between performance of pairs of subsequent actions of the actions; a trajectory of a cursor controlled by the corresponding user operating an input device; a rage clicks number during the respective session; or a dead clicks number during the respective session.

In some cases, the feedback impact score is also based on an amount of matching user journeys.

In some cases, the goal is associated with a monetary value and wherein the feedback impact score is also based on the monetary value.

In some cases, the processing circuitry is further configured to display the feedback impact score to an operator of the feedback enrichment system.

In some cases, the processing circuitry is further configured to display a recording of the feedback user journey to an operator of the feedback enrichment system.

In some cases, the processing circuitry is further configured to display a recording of one or more of the matching user journeys to an operator of the feedback enrichment system.

In some cases, the processing circuitry is further configured to display to an operator of the feedback enrichment system the series of steps associated with at least one of: (a) feedback user journey, or (b) the matching user journeys.

In some cases, the similarity criterion is identicality.

In some cases, the similarity criterion is that a given threshold of the series of steps associated with the feedback user journey and with the matching user journeys are identical.

In some cases, the given threshold is a given percentage or a given number.

In accordance with a second aspect of the presently disclosed subject matter, there is provided a feedback enrichment method, the method comprising: obtaining, by a processing circuitry, (a) user journey information of a plurality of user journeys, each performed in a respective session within a website or a computerized application, each of the user journeys including information of a respective series of actions made by a corresponding user, within the website or the computerized application, in order to achieve a goal, and (b) feedback information, indicative of feedback provided by the user associated with a feedback user journey of the user journeys; identifying, by the processing circuitry, matching user journeys of the user journeys being the user journeys that meet a similarity criterion with the feedback journey, wherein a second user associated with at least one of the matching user journeys did not provide feedback for the respective matching user journey; and determining, by the processing circuitry, a feedback impact score associated with the feedback information, based on analysis of the matching user journeys.

In some cases, the user journey information further includes performance information indicative of performance of the website or the computerized application during at least part of the respective session.

In some cases, the performance information includes an indication of a time since performance of at least one of the actions until completion of execution of code associated with the action within the website or the computerized application.

In some cases, the user journey information further includes behavioral information indicative of a behavior of the corresponding user during at least part of the respective session.

In some cases, the behavioral information includes one or more of: an indication of time passing between performance of pairs of subsequent actions of the actions; a trajectory of a cursor controlled by the corresponding user operating an input device; a rage clicks number during the respective session; or a dead clicks number during the respective session.

In some cases, the feedback impact score is also based, on an amount of matching user journeys.

In some cases, the goal is associated with a monetary value and wherein the feedback impact score is also based on the monetary value.

In some cases, the method further comprises displaying the feedback impact score to a user.

In some cases, the method further comprises displaying a recording of the feedback user journey to a user.

In some cases, the method further comprises displaying a recording of one or more of the matching user journeys to a user.

In some cases, the method further comprises displaying to a user the series of steps associated with at least one of: (a) feedback user journey, or (b) the matching user journeys.

In some cases, the similarity criterion is identicality.

In some cases, the similarity criterion is that a given threshold of the series of steps associated with the feedback user journey and with the matching user journeys are identical.

In some cases, the given threshold is a given percentage or a given number.

In accordance with a third aspect of the presently disclosed subject matter, there is provided a non-transitory computer readable storage medium having computer readable program code embodied therewith, the computer readable program code, executable by at least one processing circuitry of a computer to perform a method comprising: obtaining, by the processing circuitry, (a) user journey information of a plurality of user journeys, each performed in a respective session within a website or a computerized application, each of the user journeys including information of a respective series of actions made by a corresponding user, within the website or the computerized application, in order to achieve a goal, and (b) feedback information, indicative of feedback provided by the user associated with a feedback user journey of the user journeys; identifying, by the processing circuitry, matching user journeys of the user journeys being the user journeys that meet a similarity criterion with the feedback journey, wherein a second user associated with at least one of the matching user journeys did not provide feedback for the respective matching user journey; and determining, by the processing circuitry, a feedback impact score associated with the feedback information, based on analysis of the matching user journeys.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a block diagram schematically illustrating one example of a feedback enrichment system, in accordance with the presently disclosed subject matter; and FIG. 2 is a flowchart illustrating one example of a sequence of operations carried out for feedback enrichment, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not, to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “identifying”, “determining”, “displaying”, “processing” or the like, include action and/or processes of a computer that manipulate and/or transform data into other data, said data represented as physical quantities, e.g. such as electronic quantities, and/or said data representing the physical objects. The terms “computer”, “processor”, “processing resource”, “processing circuitry” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

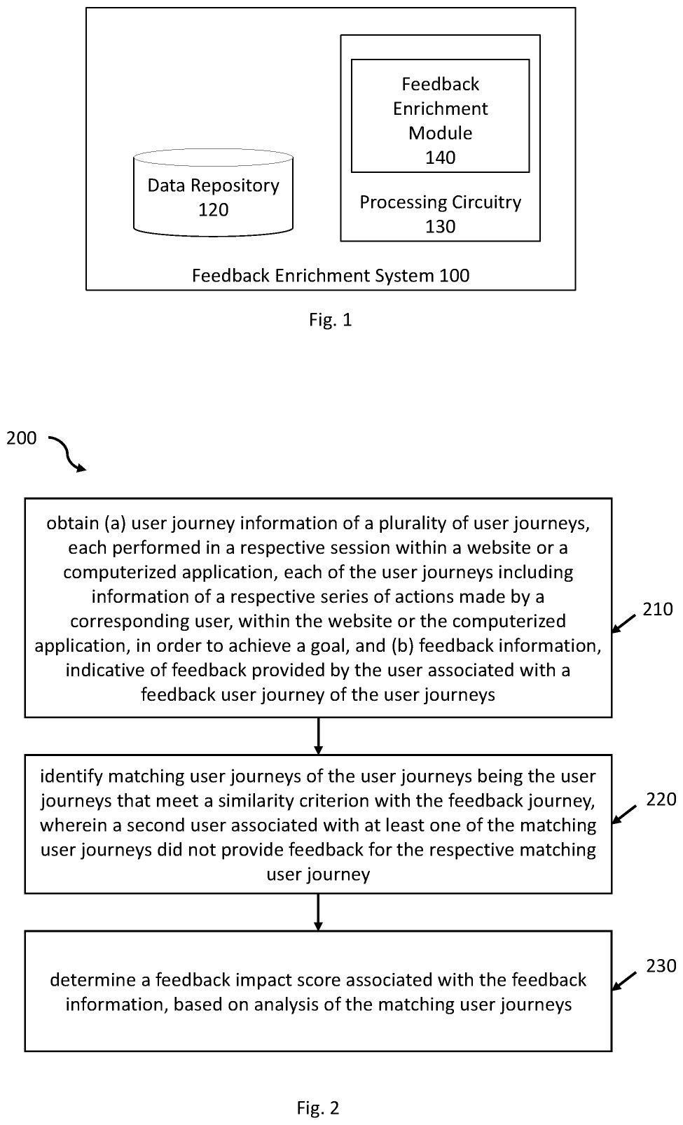

In embodiments of the presently disclosed subject matter, fewer, more and/or different stages than those shown in FIG. 2 may be executed. In embodiments of the presently disclosed subject matter one or more stages illustrated in FIG. 2 may be executed in a different order and/or one or more groups of stages may be executed simultaneously. FIG. 1 illustrate a general schematic of the system architecture in accordance with an embodiment of the presently disclosed subject matter. Each module in FIG. 1 can be made up of any combination of software, hardware and/or firmware that performs the functions as defined and explained herein. The modules in FIG. 1 may be centralized in one location or dispersed over more than one location. In other embodiments of the presently disclosed subject matter, the system may comprise fewer, more, and/or different modules than those shown in FIG. 1.

Bearing this in mind, attention is drawn to FIG. 1, showing a block diagram schematically illustrating one example of a feedback enrichment system, in accordance with the presently disclosed subject matter.

According to certain examples of the presently disclosed subject matter, the feedback enrichment system 100 can comprise, or be otherwise associated with, a data repository 120 (e.g. a database, a storage system, a memory including Read Only Memory—ROM, Random Access Memory—RAM, or any other type of memory, etc.) configured to store data, including inter alia information of a plurality of user journeys performed within one or more websites and/or within one or more computerized applications (e.g. applications that can be executed on computerized devices such as computers, smartphones, tablets, smartwatches, etc.), as further detailed herein. In some cases, data repository 230 can be further configured to enable retrieval and/or update and/or deletion of the stored data. It is to be noted that in some cases, data repository 230 can be distributed.

Feedback enrichment system 100 further comprises a processing circuitry 130. Processing circuitry 130 can be one or more processing units (e.g. central processing units), microprocessors, microcontrollers or any other computing devices or modules, including multiple and/or parallel and/or distributed processing units, which are adapted to independently or cooperatively process data for controlling relevant feedback enrichment system 100 resources and for enabling operations related to feedback enrichment system 100 resources.

The processing circuitry 130 can comprise a feedback enrichment module 140. According to some examples of the presently disclosed subject matter, feedback enrichment module 140 can be configured to enrich feedback provided by a user following performance of a user journey within a website or within a computerized application, as further detailed herein, inter alia with reference to FIG. 2, attention to which is now drawn.

FIG. 2 is a flowchart illustrating one example of a sequence of operations carried out for feedback enrichment, in accordance with the presently disclosed subject matter.

According to some examples of the presently disclosed subject matter, feedback enrichment system 100 can be configure to perform a feedback enrichment process 200, e.g. utilizing the feedback enrichment module 140.

For this purpose, feedback enrichment system 100 is configured to obtain (e.g. from the data repository 120): (a) user journey information of a plurality of user journeys, each performed in a respective session within a website or a computerized application, and each of the user journeys including information of a respective series of actions made by a corresponding user, within the website or the computerized application, in order to achieve a goal, and (b) feedback information, indicative of feedback provided by the user associated with a feedback user journey of the user journeys (block 210).

A user journey is a series of steps made by a user during a single session for achieving a goal, such as purchasing a certain good at a certain website or completing a certain task in a mobile application, etc. For example, assuming that a certain user is interested in purchasing a ticket for a flight through; a website of an airline. The user enters the website, and then starts performing a series of steps for purchasing the ticket. The series of steps can include, for example, clicking an “order flight” button, choosing an origin airport and a destination airport, choosing a date for the flight, and clicking a search button. Following clicking the search button a search is conducted and a new webpage is displayed to the user, showing a list of available flights at the selected date, and respective prices and takeoff/landing time information. The user selects a certain available flight, and then a new webpage is opened in which the available seats are displayed to the user, and he is requested to select a seat for the flight. Following selection of a seat, a new webpage is opened in which the user is requested to provide payment details. After the payment details are provided, they are verified by the airline and a new webpage is displayed showing that the order was approved and a confirmation email including the ticket was sent to the user. That is an illustrative description of an exemplary successful user journey.

However, a user journey does not always have to be successful. Looking at the example provided above, assuming that the payment details verification failed, the user may not be able to complete the purchase, and the user journey may end with the user being notified that due to the fact that the payment details verification failed—the transaction cannot be completed. Such user may choose to leave the website before successful completion of the ticket purchase task.

Even if a certain user journey is successful (as the respective user is able to achieve its goal), it does not necessarily mean that the user journey was problem free. Looking at the above example of purchasing a flight ticket, it is not inevitable that the user was not satisfied with the purchasing experience. For example, the user may have experienced long wait times between two or more of the stages of the user journey. As another example, the user may have been provided with irrelevant or misleading information during one or more of the stages. Therefore, relevant and insightful feedback can be provided both on successful user journeys and on non-successful user journeys.

The user journey information can include, for each user journey, as non limiting examples, one or more of: performance information indicative of performance of the website or the computerized application during at least part of the respective session (e.g. the processing time between each stage of the user journey, an indication of a time since performance of at least one of the actions until completion of execution of code associated with the action within the website or the computerized application, a load time of each webpage, a number of errors during the user journey, types of errors during the user journey, etc.), behavioral information indicative of a behavior of the corresponding user during at least part of the respective session (e.g. indications of time passing between performance of pairs of subsequent actions within the website or the computerized application, a trajectory of a cursor controlled by the corresponding user operating an input device at during one or more stages of the user journey, information of the actions made by the user at each stage of the respective user journey, etc.), input information indicative of the information inputted by the user during each stage of the respective user journey, identification information of the user (which can enable obtainment of characteristics of the user conducting the user journey such as age, sex, geographical location, occupation, past user journeys, etc.), web session characteristics (e.g. geographical location of the user, the Internet Service Provider (ISP) of the user, the Internet Protocol (IP) address of the user, etc.), experiential characteristics of the user during the user journey (e.g. rage clicks, dead clicks, chum. Back & Forth actions, etc.), engagement characteristics (session length, time in each webpage, number of interactions, types of interactions, etc.), or any other characteristic that is related to a user journey.

Turning to the feedback information, it is information provided by the user conducting a given user journey, on her experience conducting the given user journey. The feedback information can be a ranking of the experience (as a whole, or one or more aspects of the experience) on a given scale (e.g. a scale of one to five). The feedback information can additionally or alternatively include open text provided by the user describing her experience in a non-structured manner.

It is to be noted that in many cases, the relative number of users that leave feedback on their user journey, out of the total number of user journeys conducted within a website or another computerized application is low. In some cases, feedback can be provided on less than 5% of user journeys, or even on less than 1% of the user journeys.

Accordingly, as indicated herein, it is desirable to utilize the feedback that is provided by the users that do leave feedback to get more valuable insights. For this purpose, the feedback enrichment system 100 is further configured to identify matching, user journeys (of the user journeys that are obtained at block 210 and stored on data repository 120) being the user journeys that meet a similarity criterion with the feedback user journey (associated with the feedback information obtained at block 210) (block 220). It is to be noted that in some cases, at least one user that is associated with at least one of the matching user journeys did not provide feedback for the respective matching user journey.

It is to be noted that the similarity criterion can be identicality between the series of actions made by the user during the feedback user journey and the series of actions made by the users of the matching user journeys. In other cases, the similarity criterion can be that a given threshold of the series of steps associated with the feedback user journey and with the matching user journeys are identical (e.g. a certain percentage or a certain pre-determine or calculated number).

However, in some cases, the similarity criterion can also depend on additional parameters, other than the series of steps associated with the feedback user journey and with the matching user journeys. In some cases, the similarity criterion requires similarity (e.g. identicality or a certain percentage or number of matches) between one or more of: (a) all, or part, of the performance information associated with the feedback user journey and, with the matching user journeys, (b) all, or part, of the behavioral information associated with the feedback user journey and with the matching user journeys, (c) all, or part, of the input information associated with the feedback user journey and with the matching user journeys, (d) all, or part, of the web session characteristics (e.g. geographical location of the user, the Internet Service Provider (ISP) of the user, the Internet Protocol (IP) address of the user, etc.), (e) all, or part, of the experiential characteristics of the user during the user journey (e.g. rage clicks, dead clicks, churn, Back & Forth actions, etc.), or (f) all, or part, of the engagement, characteristics (session length, time in each webpage, number of interactions, types of interactions, etc.).

For example, a matching user journey, matching the feedback user journey, can be any user journey in which the respective user performed the same series of steps in order to achieve the same goal, and having similar performance information. Let's look at a certain feedback user journey that was provided in relation to a certain user journey. and assume that the feedback user journey indicated that the user's experience was bad due to the fact that the website's performance was very poor and he had to wait long periods of time between each step of the user journey to purchase a flight ticket. Clearly, if the website operator knew that there is a performance issue, and that it has been experienced by many users aside from the one that left the feedback—that would be very useful information for the website operator.

As detailed herein, many, and in some cases most, user's do not leave feedback on their user journeys. However, as more users attempt to accomplish a common goal, the likelihood that other users experience a user journey that meets a similarity criterion with the feedback user journey (the user journey of the user following which the user provided the feedback) increases. Such users may have decided not to leave feedback, even though their experience was similar to the experience of the user that chose to leave feedback.

Accordingly, the feedback enrichment system 100 is further configured to determine a feedback impact score associated with the feedback information, based on an amount and/or an analysis of the matching user journeys identified at block 220 (block 230).

Clearly, the more matching user journeys are identified, the feedback impact score associated with the feedback information is higher (assuming that a higher score means a higher impact, and noting that if a higher score means a lower impact than the more matching user journeys are identified the feedback impact score associated with the feedback information will be lower).

In some cases, in addition to, or as an alternative for, considering the number of matching user journeys, the matching user journeys can be analyzed to determine the feedback impact score. Looking at a specific example, negative feedback provided by a user can be a result of a technical problem with the website, or, for purpose of example, a result of removal of a certain product that the user that provided, the feedback loves from the inventory of the website owner. Understanding the reason for the negative feedback can enable determining a feedback impact score that is meaningful.

It is to be noted that in some cases, the goal that the user conducting the user session is trying to achieve can be associated with a monetary value (e.g. a price of a flight ticket). In such cases, the feedback impact score can also be based on the monetary value, so that the higher the monetary value associated with the feedback user journey, the higher the feedback score is (assuming that a higher score means a higher impact, and noting that if a higher score means a lower impact than the higher the monetary value associated with the feedback user journey the feedback impact score associated with the feedback information will be lower).

In some cases, although not shown in the flowchart, the feedback enrichment system 100 can be further configured to display the feedback impact score determined at block 230 to an operator of the feedback enrichment system 100. This can enable the operator to investigate the feedback user session and/or the matching user journeys in order to enhance insights. The feedback enrichment system 100 can be further configured to display a recording of the feedback user journey, and/or of one or more of the matching user journeys, to an operator of the feedback enrichment system. Additionally, or alternatively, the feedback enrichment system 100 can be configured to display to an operator of the feedback enrichment system the series of steps associated with at least one of: (a) feedback user journey, or (b) the matching user journeys.

It is to be noted that, with reference to FIG. 2, some of the blocks can be integrated into a consolidated block or can be broken down to a few blocks and/or other blocks may be added. It should be also, noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art, will appreciate that the conception upon which this disclosure is based may readily be utilized, as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A feedback enrichment system, the feedback enrichment system comprising a processing circuitry configured to:
obtain (a) user journey information of a plurality of user journeys, each performed in a respective session within a website or a computerized application, each of the user journeys including information of a respective series of actions made by a corresponding user, within the website or the computerized application, in order to achieve a goal, and (b) feedback information, indicative of feedback provided by the user associated with a feedback user journey of the user journeys;
identify matching user journeys of the user journeys being the user journeys that meet a similarity criterion with the feedback journey, wherein a second user associated with at least one of the matching user journeys did not provide feedback for the respective matching user journey; and
determine a feedback impact score associated with the feedback information, based on analysis of the matching user journeys.

2. The feedback enrichment system of claim 1, wherein the user journey information further includes performance information indicative of performance of the website or the computerized application during at least part of the respective session.

3. The feedback enrichment system of claim 2, wherein the performance information includes an indication of a time since performance of at least one of the actions until completion of execution of code associated with the action within the website or the computerized application.

4. The feedback enrichment system of claim 1, wherein the user journey information further includes behavioral information indicative of a behavior of the corresponding user during at least part of the respective session.

5. The feedback enrichment system of claim 4, wherein the behavioral information includes one or more of:
a. an indication of time passing between performance of pairs of subsequent actions of the actions;
b. a trajectory of a cursor controlled by the corresponding user operating an input device;
c. a rage clicks number during the respective session; or
d. a dead clicks number during the respective session.

6. The feedback enrichment system of claim 1, wherein the feedback impact score is also based on an amount of matching user journeys.

7. The feedback enrichment system of claim 1, wherein the goal is associated with a monetary value and wherein the feedback impact score is also based on the monetary value.

8. The feedback enrichment system of claim 1, wherein the processing circuitry is further configured to display, to an operator of the feedback enrichment system, the feedback impact score, or a recording of the feedback user journey, or a recording of one or more of the matching user journeys, or the series of steps associated with at least one of: (a) feedback user journey, or (b) the matching user journeys.

9. The feedback enrichment system of claim 1, wherein the similarity criterion is identicality, or that a given threshold of the series of steps associated with the feedback user journey and with the matching user journeys are identical, wherein the given threshold is a given percentage or a given number.

10. A feedback enrichment method, the method comprising:
obtaining, by a processing circuitry, (a) user journey information of a plurality of user journeys, each performed in a respective session within a website or a computerized application, each of the user journeys including information of a respective series of actions made by a corresponding user, within the website or the computerized application, in order to achieve a goal, and (b) feedback information, indicative of feedback provided by the user associated with a feedback user journey of the user journeys;
identifying, by the processing circuitry, matching user journeys of the user journeys being the user journeys that meet a similarity criterion with the feedback journey, wherein a second user associated with at least one of the matching user journeys did not provide feedback for the respective matching user journey; and
determining, by the processing circuitry, a feedback impact score associated with the feedback information, based on analysis of the matching user journeys.

11. The feedback enrichment method of claim 10, wherein the user journey information further includes performance information indicative of performance of the website or the computerized application during at least part of the respective session.

12. The feedback enrichment method of claim 11, wherein the performance information includes an indication of a time since performance of at least one of the actions until completion of execution of code associated with the action within the website or the computerized application.

13. The feedback enrichment method of claim 10, wherein the user journey information further includes behavioral information indicative of a behavior of the corresponding user during at least part of the respective session.

14. The feedback enrichment method of claim 13, wherein the behavioral information includes one or more of:
a. an indication of time passing between performance of pairs of subsequent actions of the actions;
b. a trajectory of a cursor controlled by the corresponding user operating an input device;
c. a rage clicks number during the respective session; or
d. a dead clicks number during the respective session.

15. The feedback enrichment method of claim 10, wherein the feedback impact score is also based on an amount of matching user journeys.

16. The feedback enrichment method of claim 10, wherein the goal is associated with a monetary value and wherein the feedback impact score is also based on the monetary value.

17. The feedback enrichment method of claim 10, further comprising displaying, to an operator of the feedback enrichment system, the feedback impact score, or a recording of the feedback user journey, or a recording of one or more of the matching user journeys, or the series of steps associated with at least one of: (a) feedback user journey, or (b) the matching user journeys.

18. The feedback enrichment method of claim 10, wherein the similarity criterion is identicality, or that a given threshold of the series of steps associated with the feedback user journey and with the matching user journeys are identical, wherein the given threshold is a given percentage or a given number.

19. A non-transitory computer readable storage medium having computer readable program code embodied therewith, the computer readable program code, executable by at least one processing circuitry of a computer to perform a method comprising:
obtaining, by the processing circuitry, (a) user journey information of a plurality of user journeys, each performed in a respective session within a website or a computerized application, each of the user journeys including information of a respective series of actions made by a corresponding user, within the website or the computerized application, in order to achieve a goal, and (b) feedback information, indicative of feedback provided by the user associated with a feedback user journey of the user journeys;
identifying, by the processing circuitry, matching user journeys of the user journeys being the user journeys that meet a similarity criterion with the feedback journey, wherein a second user associated with at least one of the matching user journeys did not provide feedback for the respective matching user journey; and
determining, by the processing circuitry, a feedback impact score associated with the feedback information, based on analysis of the matching user journeys.
